(19) United States
(12) Patent Application Publication
(10) Pub. No.: US 2008/0140918 A1
(43) Pub. Date: Jun. 12, 2008

(54) HYBRID NON-VOLATILE SOLID STATE MEMORY SYSTEM

(76) Inventor: Pantas Sutardja, Los Gatos, CA (US)

Correspondence Address: HARNESS, DICKEY & PIERCE P.L.C., 5445 CORPORATE DRIVE, SUITE 200, TROY, MI, 48098, US

(21) Appl. No.: 11/952,648

(22) Filed: Dec. 7, 2007

Related U.S. Application Data
(60) Provisional application No. 60/869,493, filed on Dec. 11, 2006.

(51) Int. Cl. G06F 12/02; G06F 12/00

(52) U.S. Cl. 711/103; 711/154; 711/E12.008; 711/E12.001

(57) ABSTRACT

A solid state memory system comprises a first nonvolatile semiconductor (NVS) memory that has a first write cycle lifetime, a second nonvolatile semiconductor (NVS) memory that has a second write cycle lifetime that is different than the first write cycle lifetime, and a wear leveling module. The wear leveling module generates first and second wear levels for the first and second NVS memories based on the first and second write cycle lifetimes and maps logical addresses to physical addresses of one of the first and second NVS memories based on the first and second wear levels.

### CROSS-REFERENCE TO RELATED APPLICATIONS

This application claims the benefit of U.S. Provisional Application No. 60/869,493 filed on Dec. 11, 2006. The disclosure of the above application is incorporated herein by reference in its entirety.

### FIELD

The present disclosure relates to solid state memories, and more particularly to hybrid non-volatile solid state memories.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Flash memory chips, which use charge storage devices, have become a dominant chip type for semiconductor-based mass storage devices. The charge storage devices are particularly suitable in applications where data files to be stored include music and image files. Charge storage devices, however, can sustain a limited number of write cycles after which the charge storage devices can no longer reliably store data.

A limited number of write cycles may be acceptable for many applications such as removable USB (universal serial bus) drives, MP3 (MPEG Layer 3) players, and digital camera memory cards. However, when used as general replacements for built-in primary data drives in computer systems, a limited number of write cycles may not be acceptable.

Lower density flash devices, where a single bit is stored per storage cell, typically have a usable lifetime on the order of 100,000 write cycles. To reduce cost, flash devices may store 2 bits per storage cell. Storing 2 bits per storage cell, however, may reduce the usable lifetime of the device to a level on the order of 10,000 write cycles.

Flash devices may not have a long enough lifetime to serve as mass storage, especially where part of the mass storage is used as virtual memory paging space. Virtual memory paging space is used by operating systems to store data from RAM (random access memory) when available space in RAM is low. For purposes of illustration only, a flash memory chip may have a capacity of 2 GB (gigabytes), may store 2 bits per cell, and may have a write throughput of about 4 MB/s (megabytes per second). In such a flash memory chip, it is theoretically possible to write every bit in the chip once every 500 seconds (i.e., 2E9 bytes/4E6 bytes/s).

It is then theoretically possible to write every bit 10,000 times in only 5E6 seconds (1E4 cycles*5E2 seconds), which is less than two months. In reality, however, most drive storage will not be written with 100% duty cycle. A more realistic write duty cycle may be 10%, which may happen when a computer is continuously active and performs virtual memory paging operations. At 10% write duty cycle, the usable lifetime of the flash device may be exhausted in approximately 20 months. By contrast, the life expectation for a magnetic hard disk storage device typically exceeds 10 years.

Referring now to FIG. 1, a functional block diagram of a solid-state disk according to the prior art is presented. The solid-state disk 100 includes a controller 102 and a flash memory 104. The controller 102 receives instructions and data from a host (not shown). When a memory access is requested, the controller 102 reads or writes data to the flash memory 104, and communicates this information to the host.

An area of the flash memory 104 may become unreliable for storage after it has been written to or erased a predetermined number of times. This predetermined number of times is referred to as the write cycle lifetime of the flash memory 104. Once the write cycle lifetime of the flash memory 104 has been exceeded, the controller 102 can no longer reliably store data in the flash memory 104, and the solid-state disk 100 may no longer be usable.

### SUMMARY

A solid state memory system comprises a first nonvolatile semiconductor (NVS) memory that has a first write cycle lifetime, a second nonvolatile semiconductor (NVS) memory that has a second write cycle lifetime that is different than the first write cycle lifetime, and a wear leveling module. The wear leveling module generates first and second wear levels for the first and second NVS memories based on the first and second write cycle lifetimes and maps logical addresses to physical addresses of one of the first and second NVS memories based on the first and second wear levels.

In other features, the first wear level is based on a ratio of a first number of write operations performed on the first NVS memory to the first write cycle lifetime. The second wear level is based on a ratio of a second number of write operations performed on the second NVS memory to the second write cycle lifetime. The wear leveling module maps the logical addresses to the physical addresses of the second memory when the second wear level is less than the first wear level. The first NVS memory has a first storage capacity that is greater than a second storage capacity of the second NVS memory.

In further features, the solid state memory system further comprises a mapping module that receives first and second frequencies for writing data to first and second of the logical addresses. The wear leveling module biases mapping of the first of the logical addresses to the physical addresses of the second NVS memory when the first frequency is greater than the second frequency and the second wear level is less than the first wear level.

In still other features, the wear leveling module biases mapping of the second of the logical addresses to the physical addresses of the first NVS memory. The solid state memory system further comprises a write monitoring module that monitors subsequent frequencies of writing data to the first and second of the logical addresses and that updates the first and second frequencies based on the subsequent frequencies.

In other features, the solid state memory system further comprises a write monitoring module that measures first and second frequencies of writing data to first and second of the logical addresses. The wear leveling module biases mapping of the first of the logical addresses to the physical addresses of the second NVS memory when the first frequency is greater than the second frequency and the second wear level is less than the first wear level. The wear leveling module biases mapping of the second of the logical addresses to the physical addresses of the first NVS memory.

In further features, the solid state memory system further comprises a degradation testing module that writes data at a first predetermined time to one of the physical addresses; generates a first stored data by reading data from the one of the physical addresses; writes data to the one of the physical addresses at a second predetermined time; generates a second stored data by reading data from the one of the physical addresses; and generates a degradation value for the one of the physical addresses based on the first and second stored data.

In still other features, the wear leveling module maps one of the logical addresses to the one of the physical addresses based on the degradation value. The wear leveling module maps the logical addresses to the physical addresses of the first NVS memory when the second wear level is greater than or equal to a first predetermined threshold; and the wear leveling module maps the logical addresses to the physical addresses of the second NVS memory when the first wear level is greater than or equal to a second predetermined threshold.

In other features, when write operations performed on a first block of the physical addresses of the first NVS memory during a predetermined period are greater than or equal to a predetermined threshold, the wear leveling module biases mapping of corresponding ones of the logical addresses from the first block to a second block of the physical addresses of the second NVS memory. The wear leveling module identifies a first block of the physical addresses of the second NVS memory as a least used block (LUB).

In further features, the wear leveling module biases mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises a Nitride Read-Only Memory (NROM) flash device. The first write cycle lifetime is less than the second write cycle lifetime.

A method comprises generating first and second wear levels for first and second nonvolatile semiconductor (NVS) memories based on first and second write cycle lifetimes. The first and second write cycle lifetimes correspond to the first and second NVS memories, respectively; and mapping logical addresses to physical addresses of one of the first and second NVS memories based on the first and second wear levels.

In other features, the first wear level is based on a ratio of a first number of write operations performed on the first NVS memory to the first write cycle lifetime. The second wear level is based on a ratio of a second number of write operations performed on the second NVS memory to the second write cycle lifetime. The method further comprises mapping the logical addresses to the physical addresses of the second memory when the second wear level is less than the first wear level.

In further features, the first NVS memory has a first storage capacity that is greater than a second storage capacity of the second NVS memory. The first write cycle lifetime is less than the second write cycle lifetime. The method further comprises receiving first and second frequencies for writing data to first and second of the logical addresses; and biasing mapping of the first of the logical addresses to the physical addresses of the second NVS memory when the first frequency is greater than the second frequency and the second wear level is less than the first wear level.

In still other features, the method further comprises biasing mapping of the second of the logical addresses to the physical addresses of the first NVS memory. The method further comprises monitoring subsequent frequencies of writing data to the first and second of the logical addresses; and updating the first and second frequencies based on the subsequent frequencies.

In other features, the method further comprises measuring first and second frequencies of writing data to first and second of the logical addresses; and biasing mapping of the first of the logical addresses to the physical addresses of the second NVS memory when the first frequency is greater than the second frequency and the second wear level is less than the first wear level. The method further comprises biasing mapping of the second of the logical addresses to the physical addresses of the first NVS memory.

In further features, the method further comprises writing data at a first predetermined time to one of the physical addresses; generating a first stored data by reading data from the one of the physical addresses; writing data to the one of the physical addresses at a second predetermined time; generating a second stored data by reading data from the one of the physical addresses; and generating a degradation value for the one of the physical addresses based on the first and second stored data.

In still other features, the method further comprises mapping one of the logical addresses to the one of the physical addresses based on the degradation value. The method further comprises mapping the logical addresses to the physical addresses of the first NVS memory when the second wear level is greater than or equal to a first predetermined threshold; and mapping the logical addresses to the physical addresses of the second NVS memory when the first wear level is greater than or equal to a second predetermined threshold.

In other features, when write operations performed on a first block of the physical addresses of the first NVS memory during a predetermined period are greater than or equal to a predetermined threshold, biasing mapping of corresponding ones of the logical addresses from the first block to a second block of the physical addresses of the second NVS memory. The method further comprises identifying a first block of the physical addresses of the second NVS memory as a least used block (LUB).

In further features, the method further comprises biasing mapping of corresponding ones of the logical addresses from the first block to a second block of the physical addresses of the first NVS memory when available memory in the second NVS memory is less than or equal to a predetermineed threshold. The first NVS memory comprises a flash device and the second NVS memory comprises a phase-change memory device. The first NVS memory comprises a Nitride Read-Only Memory (NROM) flash device.

A computer program stored for use by a processor for operating a solid state memory system comprises generating first and second wear levels for first and second nonvolatile semiconductor (NVS) memories based on first and second write cycle lifetimes. The first and second write cycle lifetimes correspond to the first and second NVS memories, respectively; and mapping logical addresses to physical addresses of one of the first and second NVS memories based on the first and second wear levels.

In other features, the first wear level is based on a ratio of a first number of write operations performed on the first NVS memory to the first write cycle lifetime. The second wear level is based on a ratio of a second number of write operations performed on the second NVS memory to the second write cycle lifetime. The computer program further comprises mapping the logical addresses to the physical addresses of the second memory when the second wear level is less than the first wear level.

In further features, the first NVS memory has a first storage capacity that is greater than a second storage capacity of the second NVS memory. The first write cycle lifetime is less than the second write cycle lifetime. The computer program further comprises receiving first and second frequencies for writing data to first and second of the logical addresses; and biasing mapping of the first of the logical addresses to the physical addresses of the second NVS memory when the first frequency is greater than the second frequency and the second wear level is less than the first wear level.

In still other features, the computer program further comprises biasing mapping of the second of the logical addresses to the physical addresses of the first NVS memory. The computer program further comprises monitoring subsequent frequencies of writing data to the first and second of the logical addresses; and updating the first and second frequencies based on the subsequent frequencies.

In other features, the computer program further comprises measuring first and second frequencies of writing data to first and second of the logical addresses; and biasing mapping of the first of the logical addresses to the physical addresses of the second NVS memory when the first frequency is greater than the second frequency and the second wear level is less than the first wear level. The computer program further comprises biasing mapping of the second of the logical addresses to the physical addresses of the first NVS memory.

In further features, the computer program further comprises writing data at a first predetermined time to one of the physical addresses; generating a first stored data by reading data from the one of the physical addresses; writing data to the one of the physical addresses at a second predetermined time; generating a second stored data by reading data from the one of the physical addresses; and generating a degradation value for the one of the physical addresses based on the first and second stored data.

In still other features, the computer program further comprises mapping one of the logical addresses to the one of the physical addresses based on the degradation value. The computer program further comprises mapping the logical addresses to the physical addresses of the first NVS memory when the second wear level is greater than or equal to a first predetermined threshold; and mapping the logical addresses to the physical addresses of the second NVS memory when the first wear level is greater than or equal to a second predetermined threshold.

In other features, when write operations performed on a first block of the physical addresses of the first NVS memory during a predetermined period are greater than or equal to a predetermined threshold, biasing mapping of corresponding ones of the logical addresses from the first block to a second block of the physical addresses of the second NVS memory. The computer program further comprises identifying a first block of the physical addresses of the second NVS memory as a least used block (LUB).

In further features, the computer program further comprises biasing mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises a Nitride Read-Only Memory (NROM) flash device.

A solid state memory system comprises a first nonvolatile semiconductor (NVS) memory that has a first write cycle lifetime; a second nonvolatile semiconductor (NVS) memory that has a second write cycle lifetime that is different than the first write cycle lifetime; and wear leveling means for generating first and second wear levels for the first and second NVS memories based on the first and second write cycle lifetimes and for mapping logical addresses to physical addresses of one of the first and second NVS memories based on the first and second wear levels.

In other features, the first wear level is substantially based on a ratio of a first number of write operations performed on the first NVS memory to the first write cycle lifetime. The second wear level is substantially based on a ratio of a second number of write operations performed on the second NVS memory to the second write cycle lifetime. The wear leveling means maps the logical addresses to the physical addresses of the second memory when the second wear level is less than the first wear level. The first NVS memory has a first storage capacity that is greater than a second storage capacity of the second NVS memory.

In further features, the first write cycle lifetime is less than the second write cycle lifetime. The solid state memory system further comprises mapping means for receiving first and second frequencies for writing data to first and second of the logical addresses. The wear leveling means biases mapping of the first of the logical addresses to the physical addresses of the second NVS memory when the first frequency is greater than the second frequency and the second wear level is less than the first wear level.

In still other features, the wear leveling means biases mapping of the second of the logical addresses to the physical addresses of the first NVS memory. The solid state memory system further comprises write monitoring means for monitoring subsequent frequencies of writing data to the first and second of the logical addresses and for updating the first and second frequencies based on the subsequent frequencies.

In other features, the solid state memory system further comprises write monitoring means for measures first and second frequencies of writing data to first and second of the logical addresses. The wear leveling means biases mapping of the first of the logical addresses to the physical addresses of the second NVS memory when the first frequency is greater than the second frequency and the second wear level is less than the first wear level. The wear leveling means biases mapping of the second of the logical addresses to the physical addresses of the first NVS memory.

In further features, the solid state memory system further comprises degradation testing means for writing data at a first predetermined time to one of the physical addresses; generating a first stored data by reading data from the one of the physical addresses; writing data to the one of the physical addresses at a second predetermined time; generating a second stored data by reading data from the one of the physical addresses; and generating a degradation value for the one of the physical addresses based on the first and second stored data.

In still other features, the wear leveling means maps one of the logical addresses to the one of the physical addresses based on the degradation value. The wear leveling means maps the logical addresses to the physical addresses of the first NVS memory when the second wear level is greater than or equal to a first predetermined threshold; and the wear leveling means maps the logical addresses to the physical addresses of the second NVS memory when the first wear level is greater than or equal to a second predetermined threshold.

In other features, when write operations performed on a first block of the physical addresses of the first NVS memory during a predetermined period are greater than or equal to a predetermined threshold, the wear leveling means biases mapping of corresponding ones of the logical addresses from the first block to a second block of the physical addresses of the second NVS memory. The wear leveling means identifies a first block of the physical addresses of the second NVS memory as a least used block (LUB).

In further features, the wear leveling means biases mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises a Nitride Read-Only Memory (NROM) flash device.

A solid state memory system comprises a first nonvolatile semiconductor (NVS) memory having a first access time and a first capacity; a second nonvolatile semiconductor (NVS) memory having a second access time that is less than the first access time and a second capacity that is different than the first capacity; and a mapping module that maps logical addresses to physical addresses of one of the first and second NVS memories based on at least one of the first access time, the second access time, the first capacity, and the second capacity.

In other features, the mapping module caches data to the second NVS memory. The solid state memory system further comprises a wear leveling module that monitors first and second wear levels of the first and second NVS memories, respectively. The first and second NVS memories have first and second write cycle lifetimes, respectively.

In further features, the first wear level is substantially based on a ratio of a first number of write operations performed on the first NVS memory to the first write cycle lifetime. The second wear level is substantially based on a ratio of a second number of write operations performed on the second NVS memory to the second write cycle lifetime. The wear leveling module maps the logical addresses to the physical addresses of the second memory when the second wear level is less than the first wear level.

In still other features, the mapping module that receives first and second frequencies for writing data to first and second of the logical addresses. The wear leveling module biases mapping of the first of the logical addresses to the physical addresses of the second NVS memory when the first frequency is greater than the second frequency and the second wear level is less than the first wear level. The wear leveling module biases mapping of the second of the logical addresses to the physical addresses of the first NVS memory.

In other features, the solid state memory system further comprises a write monitoring module that monitors subsequent frequencies of writing data to the first and second of the logical addresses and that updates the first and second frequencies based on the subsequent frequencies. The solid state memory system further comprises a write monitoring module that measures first and second frequencies of writing data to first and second of the logical addresses. The wear leveling module biases mapping of the first of the logical addresses to the physical addresses of the second NVS memory when the first frequency is greater than the second frequency and the second wear level is less than the first wear level.

In further features, the wear leveling module biases mapping of the second of the logical addresses to the physical addresses of the first NVS memory. The solid state memory system further comprises a degradation testing module that writes data at a first predetermined time to one of the physical addresses; generates a first stored data by reading data from the one of the physical addresses; writes data to the one of the physical addresses at a second predetermined time; generates a second stored data by reading data from the one of the physical addresses; and generates a degradation value for the one of the physical addresses based on the first and second stored data.

In still other features, the wear leveling module maps one of the logical addresses to the one of the physical addresses based on the degradation value. The wear leveling module maps the logical addresses to the physical addresses of the first NVS memory when the second wear level is greater than or equal to a predetermined threshold; and the wear leveling module maps the logical addresses to the physical addresses of the second NVS memory when the first wear level is greater than or equal to a predetermined threshold.

In other features, when write operations performed on a first block of the physical addresses of the first NVS memory during a predetermined period are greater than or equal to a predetermined threshold, the wear leveling module biases mapping of corresponding ones of the logical addresses from the first block to a second block of the physical addresses of the second NVS memory. The wear leveling module identifies a first block of the physical addresses of the second NVS memory as a least used block (LUB).

In further features, the wear leveling module biases mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises an Nitride Read-Only Memory (NROM) flash device.

A method comprises receiving access commands including logical addresses; and mapping the logical addresses to physical addresses of one of first and second nonvolatile semiconductor (NVS) memories based on at least one of a first access time, a second access time, a first capacity, and a second capacity. The first NVS memory has the first access time and the first capacity and the NVS memory has the second access time, which is less than the first access time, and the second capacity, which is less than the first capacity.

In other features, the method further comprises caching data to the second NVS memory. The method further comprises monitoring first and second wear levels of the first and second NVS memories, respectively. The first and second NVS memories have first and second write cycle lifetimes, respectively. The first wear level is substantially based on a ratio of a first number of write operations performed on the first NVS memory to the first write cycle lifetime. The second wear level is substantially based on a ratio of a second number of write operations performed on the second NVS memory to the second write cycle lifetime.

In further features, the method further comprises mapping the logical addresses to the physical addresses of the second memory when the second wear level is less than the first wear level. The method further comprises receiving first and second frequencies for writing data to first and second of the logical addresses; and biasing mapping of the first of the logical addresses to the physical addresses of the second NVS memory when the first frequency is greater than the second frequency and the second wear level is less than the first wear level.

In still other features, the method further comprises biasing mapping of the second of the logical addresses to the physical addresses of the first NVS memory. The method further comprises monitoring subsequent frequencies of writing data to the first and second of the logical addresses; and updating the first and second frequencies based on the subsequent frequencies. The method further comprises measuring first and second frequencies of writing data to first and second of the logical addresses; and biasing mapping of the first of the logical addresses to the physical addresses of the second NVS memory when the first frequency is greater than the second frequency and the second wear level is less than the first wear level.

In other features, the method further comprises biasing mapping of the second of the logical addresses to the physical addresses of the first NVS memory. The method further comprises writing data at a first predetermined time to one of the physical addresses; generating a first stored data by reading data from the one of the physical addresses; writing data to the one of the physical addresses at a second predetermined time; generating a second stored data by reading data from the one of the physical addresses; and generating a degradation value for the one of the physical addresses based on the first and second stored data.

In other features, the method further comprises mapping one of the logical addresses to the one of the physical addresses based on the degradation value. The method further comprises mapping the logical addresses to the physical addresses of the first NVS memory when the second wear level is greater than or equal to a predetermined threshold; and mapping the logical addresses to the physical addresses of the second NVS memory when the first wear level is greater than or equal to a predetermined threshold.

In still other features, when write operations performed on a first block of the physical addresses of the first NVS memory during a predetermined period are greater than or equal to a predetermined threshold, biasing mapping of corresponding ones of the logical addresses from the first block to a second block of the physical addresses of the second NVS memory. The method further comprises identifying a first block of the physical addresses of the second NVS memory as a least used block (LUB).

In other features, the method further comprises biasing mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises a Nitride Read-Only Memory (NROM) flash device.

A computer program stored for use by a processor for operating a solid state memory system comprises receiving access commands including logical addresses; and mapping the logical addresses to physical addresses of one of first and second nonvolatile semiconductor (NVS) memories based on at least one of a first access time, a second access time, a first capacity, and a second capacity. The first NVS memory has the first access time and the first capacity and the NVS memory has the second access time, which is less than the first access time, and the second capacity, which is less than the first capacity.

In other features, the computer program further comprises caching data to the second NVS memory. The computer program further comprises monitoring first and second wear levels of the first and second NVS memories, respectively. The first and second NVS memories have first and second write cycle lifetimes, respectively. The first wear level is substantially based on a ratio of a first number of write operations performed on the first NVS memory to the first write cycle lifetime. The second wear level is substantially based on a ratio of a second number of write operations performed on the second NVS memory to the second write cycle lifetime.

In further features, the computer program further comprises mapping the logical addresses to the physical addresses of the second memory when the second wear level is less than the first wear level. The computer program further comprises receiving first and second frequencies for writing data to first and second of the logical addresses; and biasing mapping of the first of the logical addresses to the physical addresses of the second NVS memory when the first frequency is greater than the second frequency and the second wear level is less than the first wear level.

In still other features, the computer program further comprises biasing mapping of the second of the logical addresses to the physical addresses of the first NVS memory. The computer program further comprises monitoring subsequent frequencies of writing data to the first and second of the logical addresses; and updating the first and second frequencies based on the subsequent frequencies.

In other features, the computer program further comprises measuring first and second frequencies of writing data to first and second of the logical addresses; and biasing mapping of the first of the logical addresses to the physical addresses of the second NVS memory when the first frequency is greater than the second frequency and the second wear level is less than the first wear level. The computer program further comprises biasing mapping of the second of the logical addresses to the physical addresses of the first NVS memory.

In further features, the computer program further comprises writing data at a first predetermined time to one of the physical addresses; generating a first stored data by reading data from the one of the physical addresses; writing data to the one of the physical addresses at a second predetermined time; generating a second stored data by reading data from the one of the physical addresses; and generating a degradation value for the one of the physical addresses based on the first and second stored data.

In still other features, the computer program further comprises mapping one of the logical addresses to the one of the physical addresses based on the degradation value. The computer program further comprises mapping the logical addresses to the physical addresses of the first NVS memory when the second wear level is greater than or equal to a predetermined threshold; and mapping the logical addresses to the physical addresses of the second NVS memory when the first wear level is greater than or equal to a predetermined threshold.

In other features, when write operations performed on a first block of the physical addresses of the first NVS memory during a predetermined period are greater than or equal to a predetermined threshold, biasing mapping of corresponding ones of the logical addresses from the first block to a second block of the physical addresses of the second NVS memory. The computer program further comprises identifying a first block of the physical addresses of the second NVS memory as a least used block (LUB).

In further features, the computer program further comprises biasing mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises a Nitride Read-Only Memory (NROM) flash device.

A solid state memory system comprises a first nonvolatile semiconductor (NVS) memory having a first access time and a first capacity; a second nonvolatile semiconductor (NVS) memory having a second access time that is less than the first access time and a second capacity that is different than the first capacity; and mapping means for mapping logical addresses to physical addresses of one of the first and second NVS memories based on at least one of the first access time, the second access time, the first capacity, and the second capacity.

In other features, the mapping means caches data to the second NVS memory. The solid state memory system further comprises wear leveling means for monitoring first and second wear levels of the first and second NVS memories, respectively. The first and second NVS memories have first and second write cycle lifetimes, respectively. The first wear level is substantially based on a ratio of a first number of write operations performed on the first NVS memory to the first write cycle lifetime. The second wear level is substantially based on a ratio of a second number of write operations performed on the second NVS memory to the second write cycle lifetime.

In further features, the wear leveling means maps the logical addresses to the physical addresses of the second memory when the second wear level is less than the first wear level. The mapping means receives first and second frequencies for writing data to first and second of the logical addresses. The wear leveling means biases mapping of the first of the logical addresses to the physical addresses of the second NVS memory when the first frequency is greater than the second frequency and the second wear level is less than the first wear level.

In still other features, the wear leveling means biases mapping of the second of the logical addresses to the physical addresses of the first NVS memory. The computer program further comprises write monitoring means that monitors subsequent frequencies of writing data to the first and second of the logical addresses and that updates the first and second frequencies based on the subsequent frequencies.

In other features, the computer program further comprises write monitoring means for measuring first and second frequencies of writing data to first and second of the logical addresses. The wear leveling means biases mapping of the first of the logical addresses to the physical addresses of the second NVS memory when the first frequency is greater than the second frequency and the second wear level is less than the first wear level. The wear leveling means biases mapping of the second of the logical addresses to the physical addresses of the first NVS memory.

In further features, the computer program further comprises degradation testing means for writing data at a first predetermined time to one of the physical addresses; generating a first stored data by reading data from the one of the physical addresses; writing data to the one of the physical addresses at a second predetermined time; generating a second stored data by reading data from the one of the physical addresses; and generating a degradation value for the one of the physical addresses based on the first and second stored data.

In still other features, the wear leveling means maps one of the logical addresses to the one of the physical addresses based on the degradation value. The wear leveling means maps the logical addresses to the physical addresses of the first NVS memory when the second wear level is greater than or equal to a predetermined threshold; and the wear leveling means maps the logical addresses to the physical addresses of the second NVS memory when the first wear level is greater than or equal to a predetermined threshold.

In other features, when write operations performed on a first block of the physical addresses of the first NVS memory during a predetermined period are greater than or equal to a predetermined threshold, the wear leveling means biases mapping of corresponding ones of the logical addresses from the first block to a second block of the physical addresses of the second NVS memory. The wear leveling means identifies a first block of the physical addresses of the second NVS memory as a least used block (LUB).

In further features, the wear leveling means biases mapping of corresponding ones of the logical addresses from the first block to a second block of the physical addresses of the first NVS memory when available memory in the second NVS memory is less than or equal to a predetermined threshold. The first NVS memory comprises a flash device and the second NVS memory comprises a phase-change memory device. The first NVS memory comprises an Nitride Read-Only Memory (NROM) flash device.

In still other features, the systems and methods described above are implemented by a computer program executed by one or more processors. The computer program can reside on a computer readable medium such as but not limited to memory, non-volatile data storage and/or other suitable tangible storage mediums.

Further areas of applicability of the present disclosure will become apparent from the detailed description provided hereinafter. It should be understood that the detailed description and specific examples, while indicating the preferred embodiment of the disclosure, are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a solid state disk drive according to the prior art;

FIG. 2 is a functional block diagram of a solid state disk drive according to the present disclosure;

FIG. 3 is a functional block diagram of a solid state disk drive comprising a wear leveling module;

FIG. 4A is a functional block diagram of a solid state disk drive comprising the wear leveling module of FIG. 3 and a write monitoring module;

FIG. 4B is a functional block diagram of a solid state disk drive comprising the wear leveling module FIG. 3 and a write mapping module;

FIG. 5 is a functional block diagram of a solid state disk drive comprising a degradation testing module and the wear leveling module of FIG. 3 that includes the write monitoring module and the write mapping module;

FIG. 6 is a functional block diagram of a solid state disk drive including a mapping module and the wear leveling module of FIG. 3 that includes the write monitoring module and the write mapping module;

FIGS. 7A-7E are exemplary flowcharts of a method for operating the solid state disk drives illustrated in FIGS. 2-5;

FIG. 8 is an exemplary flowchart of a method for operating the solid state disk drive illustrated in FIG. 6;

FIG. 9A is a functional block diagram of a high definition television;

FIG. 9B is a functional block diagram of a vehicle control system;

FIG. 9C is a functional block diagram of a cellular phone;

FIG. 9D is a functional block diagram of a set top box; and

FIG. 9E is a functional block diagram of a mobile device.

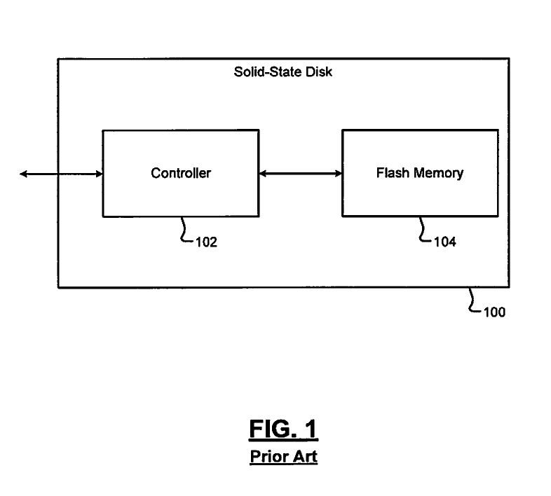

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure. As used herein, the term “based on” or “substantially based on” refers to a value that is a function of, proportional to, varies with, and/or has a relationship to another value. The value may be a function of, proportional to, vary with, and/or have a relationship to one or more other values as well.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

The cost of charge-storage-based flash devices such as Nitride Read-Only Memory (NROM) and NAND flash has been decreasing in recent years. At the same time, new high-density memory technologies are being developed. Some of these memory technologies, such as phase change memory (PCM), may provide significantly higher write endurance capability than charge-storage-based flash devices. However, being newer technologies, the storage capacity, access time, and/or cost of these memories may be less attractive than the storage capacity, access time, and/or cost of the flash devices.

To combine the longer write cycle lifetime of new memory technologies with the low cost of traditional technologies, a solid-state memory system can be constructed using both types of memory. Large amounts of low cost memory may be combined with smaller amounts of memory having a higher write cycle lifetime. The memory having the higher write cycle lifetime can be used for storing frequently changing data, such as operating system paging data.

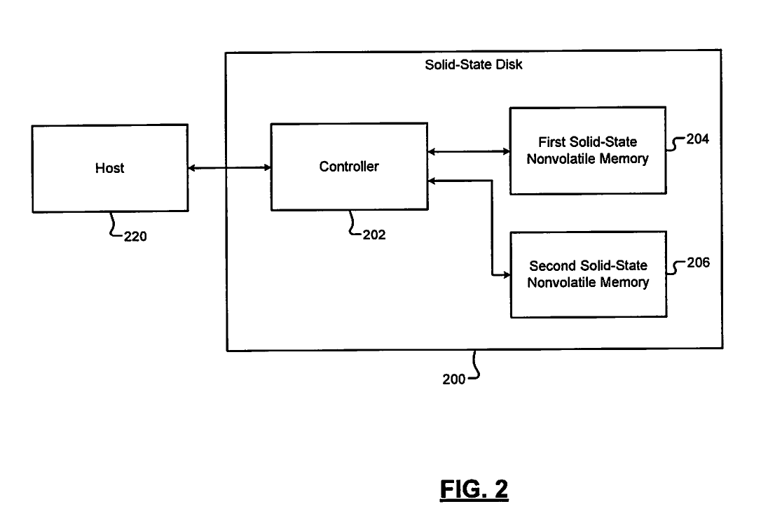

FIG. 2 depicts an exemplary solid-state memory system. The solid-state memory system may be used as a solid-state disk in a computer system. For example only, a PCM chip, such as a 2 GB PCM chip, may be combined with NAND flash devices or NROM flash devices. The write cycle lifetime of PCM memory may soon be of the order of 1E13 write cycles. PCM chips having a write cycle lifetime in excess of 1E7 write cycles are available. At 1E7 write cycles, a PCM chip has a write cycle lifetime that is 1000 times longer than a 2 bit/cell flash device that can endure 1E4 write cycles.

PCM chips may provide faster data throughput than the flash device. For example, a PCM chip may provide 100 times faster data throughput than the flash device. Even if the PCM chip provides 100 times faster data throughput than the flash device, the 1000 time greater write cycle lifetime yields an effective write cycle lifetime that is 10 times longer than the flash device. For example, at 10% write duty cycle, it would take 15.9 years to exhaust the lifetime of the PCM chip even if the PCM chip provides 100 times faster data throughput than the flash device.

In FIG. 2, a functional block diagram of an exemplary solid-state disk 200 according to the present disclosure is presented. The solid-state disk 200 includes a controller 202 and first and second solid-state nonvolatile memories 204 and 206. Throughout the remainder of this disclosure, solid-state nonvolatile memories may be implemented as integrated circuits (IC). The controller 202 receives access requests from a host 220. The controller 202 directs the access requests to the first solid-state nonvolatile memory 204 or the second solid-state nonvolatile memory 206, as will be described below.

For example only, the first solid-state nonvolatile memory 204 may include relatively inexpensive nonvolatile memory arrays and have a large capacity. The second solid-state nonvolatile memory 206 may have a greater write cycle lifetime while being more expensive and having a smaller capacity than the first solid-state nonvolatile memory 204. In various implementations, the host 220 may specify to the controller 202 the logical addresses that correspond to data that will change relatively frequently and the logical addresses that correspond to data that will change relatively infrequently.

The controller 202 may map the logical addresses corresponding to data that will change relatively frequently to physical addresses in the second solid-state nonvolatile memory 206. The controller 202 may map the logical addresses corresponding to data that will change relatively infrequently to physical addresses in the first solid-state nonvolatile memory 204.

The first solid-state nonvolatile memory 204 may include single-level cell (SLC) flash memory or multi-level cell (MLC) flash memory. The second solid-state nonvolatile memory 206 may include single-level cell (SLC) flash memory or multi-level cell (MLC) flash memory.

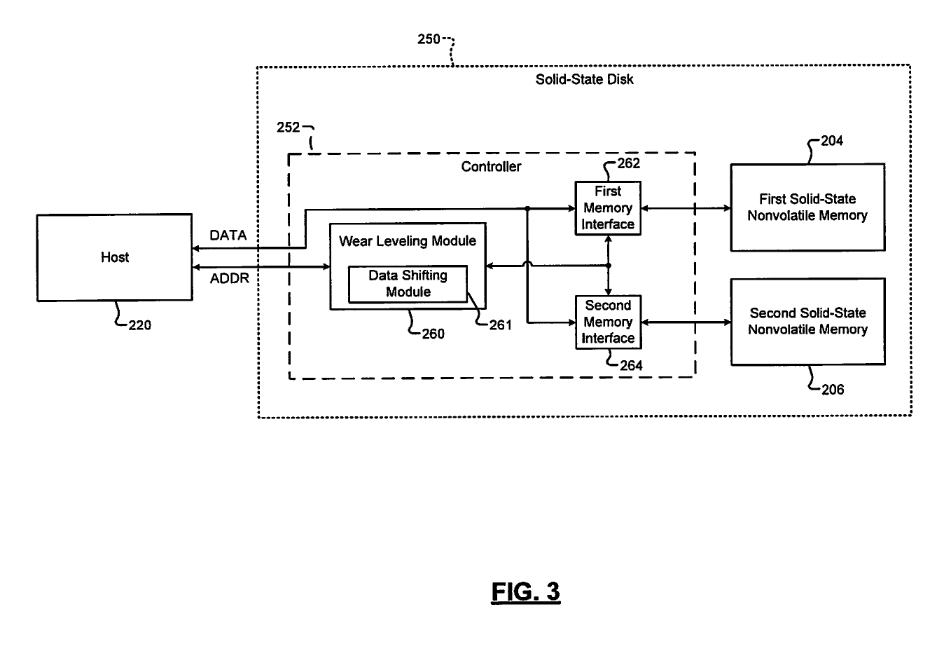

Before a detailed discussion, a brief description of drawings is presented. FIG. 3 depicts an exemplary solid-state disk including a wear leveling module. The wear leveling module controls mapping between logical addresses from the host 220 to physical addresses in the first and second solid-state memories 204 and 206. The wear leveling module may perform this mapping based on information from the host.

Alternatively or additionally, the wear leveling module may measure or estimate the wear across the solid-state nonvolatile memories and change the mapping to equalize wear across the solid-state nonvolatile memories. The goal of the wear leveling module may be to level the wear across all the areas of the solid-state nonvolatile memories so that no one area wears out before the rest of the areas of the solid-state nonvolatile memories.

With various nonvolatile memories, writing data to a block may require erasing or writing to the entire block. In such a block-centric memory, the wear leveling module may track the number of times that each block has been erased or written. When a write request arrives from the host, the wear leveling module may select the block of memory that has been written to the least from among the available blocks. The wear leveling module then maps the incoming logical address to the physical address of this block. Over time, this may produce a nearly uniform distribution of write operations across memory blocks.

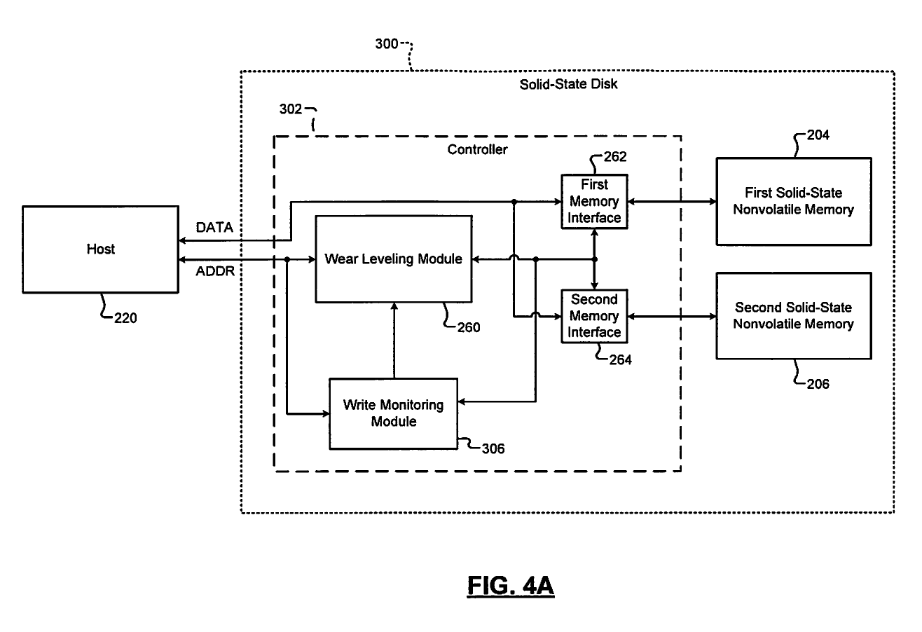

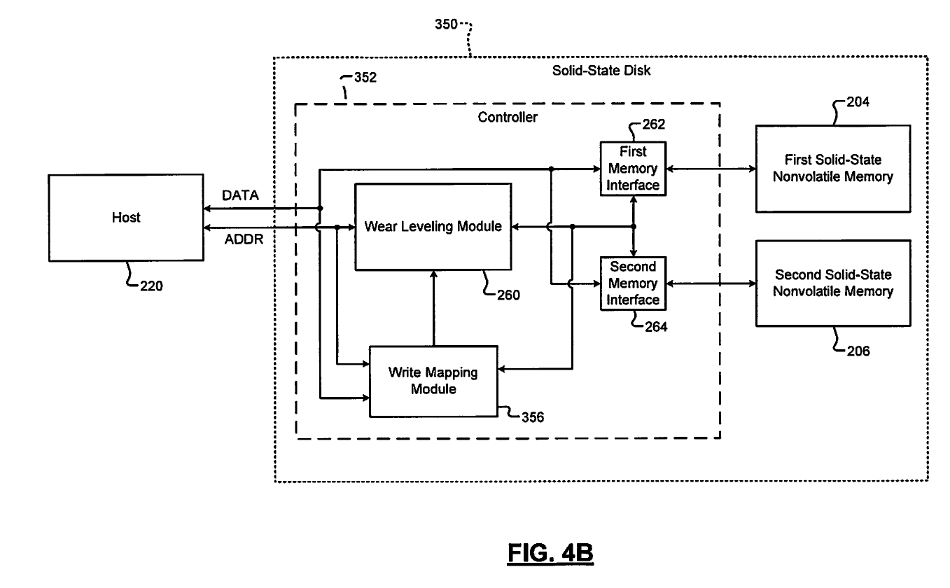

FIGS. 4A and 4B include additional modules that help to control wear leveling. In FIG. 4A, the wear leveling module determines how frequently data is written to each of the logical addresses. Logical addresses that are the target of relatively frequent writes or erases should be mapped to physical addresses that have not experienced as much wear.

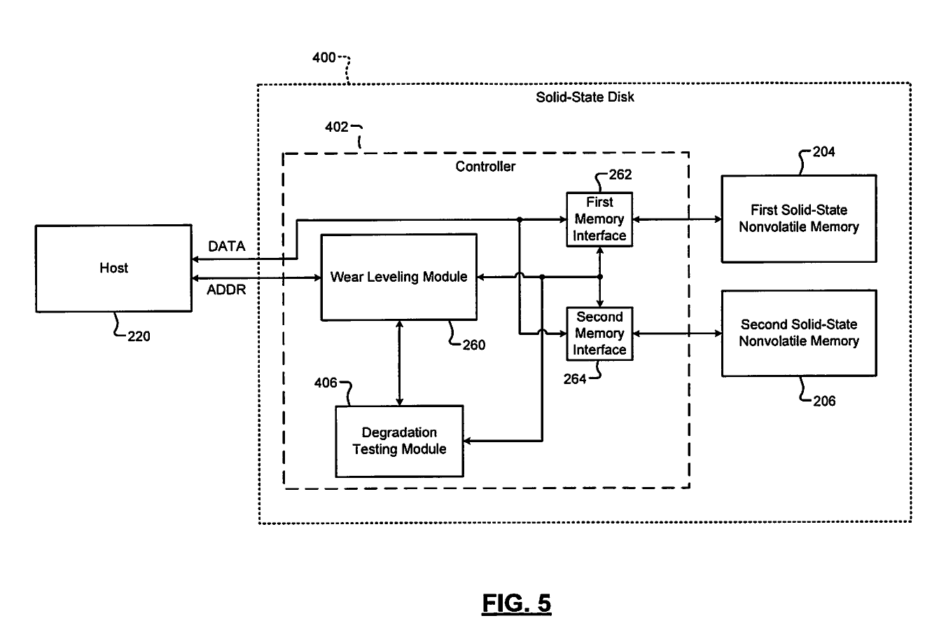

In FIG. 4B, a write mapping module receives write frequency information from the host 220. The write frequency information identifies the logical addresses that correspond to data that is expected to change relatively frequently and/or the logical addresses that correspond to data that is expected to change relatively infrequently. In addition, the write mapping module may determine how frequently data is actually written to the logical addresses, as in FIG. 4A. FIG. 5 shows a solid-state disk where degradation of the memory and resulting remaining life is determined empirically, in addition to or instead of estimating remaining life based on the number of writes or erases.

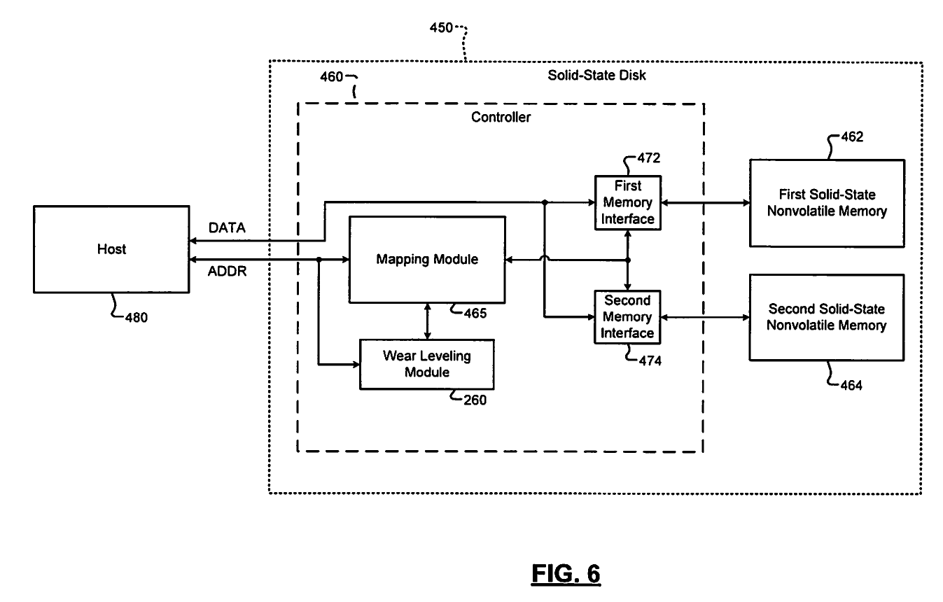

FIG. 6 shows a solid-state disk where a combination of first and second solid-state nonvolatile memories is used for caching data. The first solid-state nonvolatile memory may be inexpensive and may therefore have a high storage capacity. The second solid-state nonvolatile memory may have a faster access time than the first memory, but may be more expensive and may therefore be a smaller capacity. The first and second memories may both have high write cycle lifetimes.

A mapping module may be used to map logical addresses from a host to the first and second memories based on access time considerations. The mapping module may receive access time information from the host, such as a list of addresses for which quick access times are or are not desirable. Alternatively or additionally, the mapping module may monitor accesses to logical addresses, and determine for which logical addresses reduced access times would be most beneficial. The logical addresses for which low access times are important may be mapped to the second memory, which has reduced access times.

As used herein, access times may include, for example, read times, write times, erase times, and/or combined access times that incorporate one or more of the read, write, or erase times. For example, a combined access time may be an average of the read, write, and erase times. By directing certain logical addresses to be mapped to the second memory, the host may optimize storage for operations such as fast boot time or application startup. The mapping module may also be in communication with a wear leveling module that adapts the mapping to prevent any one area in the first and second memories from wearing out prematurely.

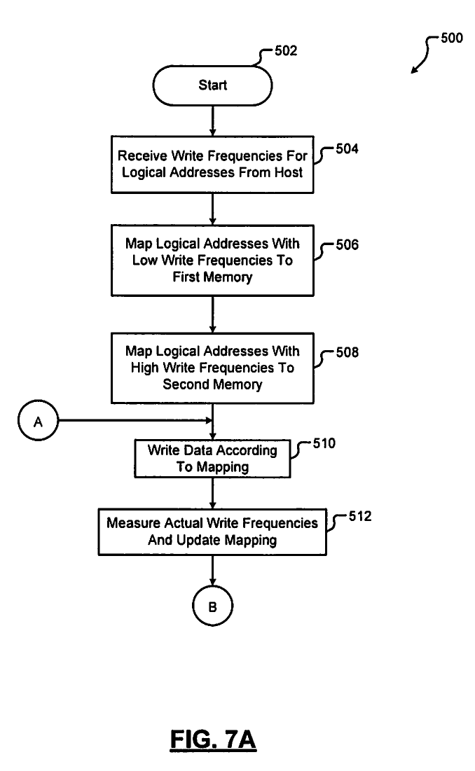

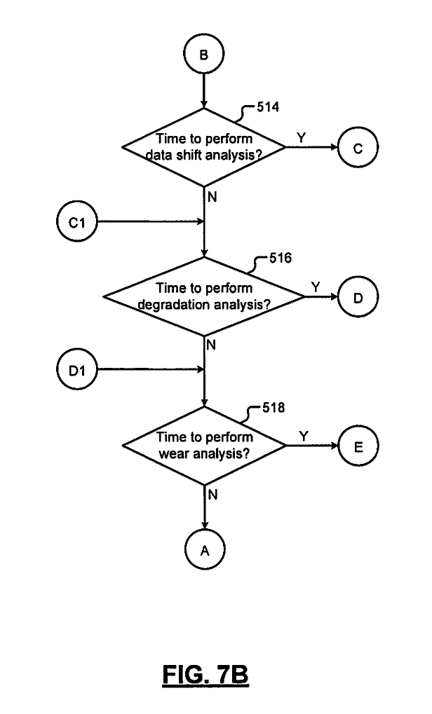

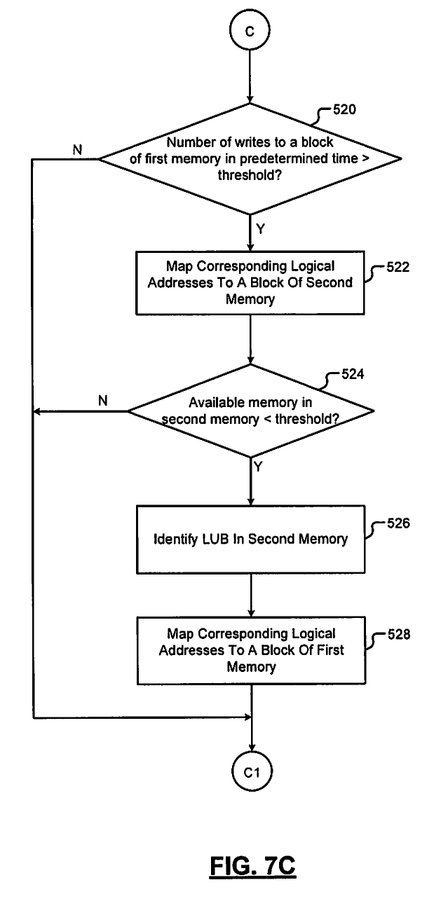

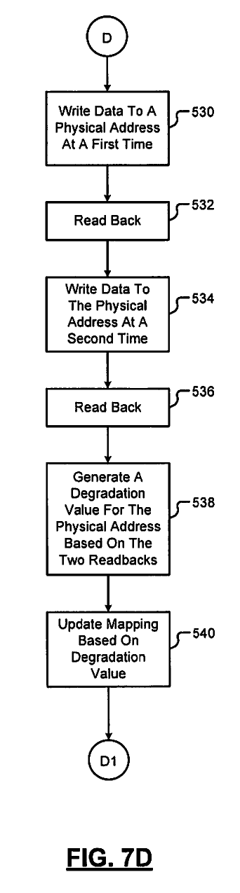

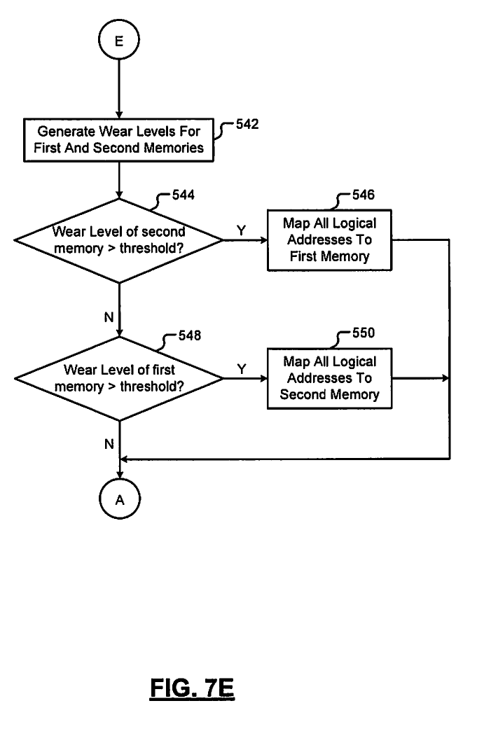

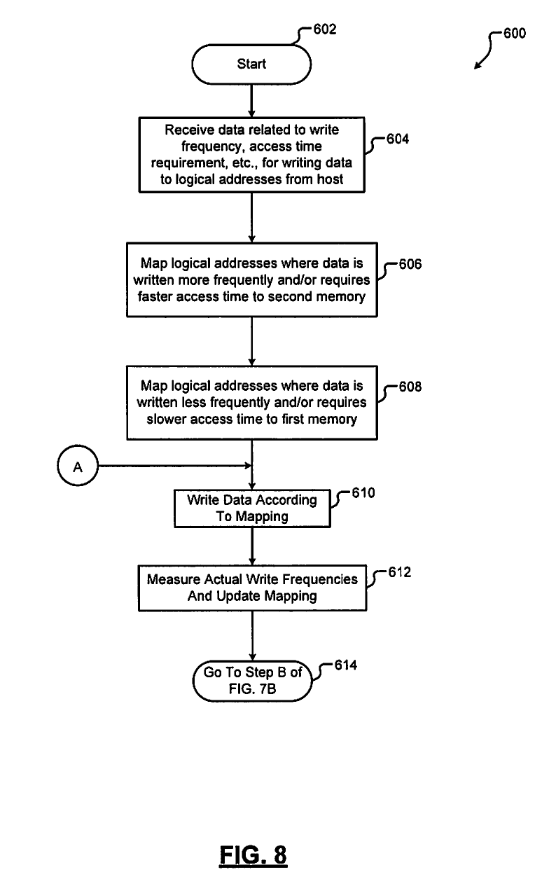

FIGS. 7A-7E depict exemplary steps performed by the controllers shown in FIGS. 4A-5. FIG. 8 depicts exemplary steps performed by the controller shown in FIG. 6. A detailed discussion of the systems and methods shown in FIGS. 2-8 is now presented.

Referring now to FIG. 3, a solid-state disk 250 includes a controller 252 and the first and second solid-state nonvolatile memories 204 and 206. The controller 252 communicates with the host 220. The controller 252 comprises a wear leveling module 260 and first and second memory interfaces 262 and 264. The wear leveling module 260 communicates with the first and second solid-state nonvolatile memory 204 via first and second memory interfaces 262 and 264, respectively.

The wear leveling module 260 receives logical addresses from the host 220. The logical addresses are converted into physical addresses associated with the first memory interface 262 and/or the second memory interface 264. During a write operation, data from the host 220 is written to the first solid-state nonvolatile memory 204 via the first memory interface 262 or to the second solid-state nonvolatile memory 206 via the second memory interface 264. During a read operation, data is provided to the host 220 from the first or second solid-state nonvolatile memory 204 and 206 via the first or second memory interface 262 and 264, respectively.

For example only, the first solid-state nonvolatile memory 204 may be relatively inexpensive per megabyte of capacity and may therefore have a large capacity. The second solid-state nonvolatile memory 206 may have a longer write cycle lifetime and may be more expensive than the first solid-state nonvolatile memory 204, and may therefore have a smaller capacity.

The first and second solid-state nonvolatile memories 204 and 206 may be written to and/or erased in blocks. For example, in order to erase one byte in a block, the entire block may be erased. In addition, in order to write one byte of a block, all bytes of the block may be written. The wear leveling module 260 may track and store the number of write and/or erase operations performed on the blocks of the first and second solid-state nonvolatile memories 204 and 206.

The wear leveling module 260 may use a normalized version of the write and/or erase cycle counts. For example, the number of write cycles performed on a block in the first solid-state nonvolatile memory 204 may be divided by the total number of write cycles that a block in the first solid-state nonvolatile memory 204 can endure. A normalized write cycle count for a block in the second solid-state nonvolatile memory 206 may be obtained by dividing the number of write cycles already performed on that block by the number of write cycles that the block can endure.

The wear leveling module 260 may write new data to the block that has the lowest normalized write cycle count. To avoid fractional write cycle counts, the write cycle counts can be normalized by multiplying the write cycle counts by constants based on the write cycle lifetime of the respective memories 204 and 206. For example, the number of write cycles performed on a block of the first solid-state nonvolatile memory 204 may be multiplied by a ratio. The ratio may be the write cycle lifetime of the second solid-state nonvolatile memory 206 divided by the write cycle lifetime of the first solid-state nonvolatile memory 204.

In various implementations, the write cycle count may only be partially normalized. For example, the write cycle lifetime of the second solid-state nonvolatile memory 206 may be significantly higher than the write cycle lifetime of the first solid-state nonvolatile memory 204. In such a case, the write cycle count of the first solid-state nonvolatile memory 204 may be normalized using a write cycle lifetime that is less than the actual write cycle lifetime. This may prevent the wear leveling module 260 from being too heavily biased toward assigning addresses to the second solid-state nonvolatile memory 206.

The normalization may be performed using a predetermined factor. For example, if the write cycle lifetime of the first solid-state nonvolatile memory 204 is 1E6, and for a given application of the solid-state disk 250, the necessary write cycle lifetime of the second solid-state nonvolatile memory 206 is 1E9, the normalization can be performed using a factor of 1,000. The factor may be a rounded off estimate and not an exact calculation. For example, a factor of 1000 may be used when respective write cycle lifetimes are 4.5E6 and 6.3E9.

The wear leveling module 260 may include a data shifting module 261 that identifies a first block wherein data stored is unchanged over a predetermined period of time. Such data may be called static data. The static data may be moved to a second block of memory that has experienced more frequent write cycles than the first block. The wear leveling module 260 may map the logical addresses that were originally mapped to the physical addresses of the first block, to the physical addresses of the second block. Since the static data is now stored in the second block, the second block may experience fewer write cycles.

Additionally, static data may be shifted from the second solid-state nonvolatile memory 206 to the first solid-state nonvolatile memory 204. For example, the data shifting module 261 may identify a least used block (LUB) of the second solid-state nonvolatile memory 206. If a number of write operations performed on a block during a predetermined period is less than or equal to a predetermined threshold, the block is called a LUB. When the amount of usable or available memory in the second solid-state nonvolatile memory 206 decreases to a predetermined threshold, the wear leveling module 260 may map the LUB to a block of the first solid-state nonvolatile memory 204.

Occasionally, the number of write operations performed on a first block of the first solid-state nonvolatile memory 204 may exceed a predetermined threshold. The wear leveling module 260 may bias mapping of logical addresses that were originally mapped to the first block, to a second block of the second solid-state nonvolatile memory 206 thereby reducing the wear on the first solid-state nonvolatile memory 204.

Referring now to FIG. 4A, a solid-state disk 300 includes a controller 302 that interfaces with the host 220. The controller 302 includes the wear leveling module 260, a write monitoring module 306, and the first and second memory interfaces 262 and 264. The write monitoring module 306 monitors logical addresses received from the host 220. The write monitoring module 306 may also receive control signals indicating whether a read or a write operation is occurring. Additionally, the write monitoring module 306 tracks the logical addresses to which data is frequently written by measuring frequencies at which data is written to the logical addresses. This information is provided to the wear leveling module 260, which biases the logical addresses to the second solid-state nonvolatile memory 206.

Referring now to FIG. 4B, a solid-state disk 350 includes a controller 352, which interfaces with the host 220. The controller 352 includes the wear leveling module 260, a write mapping module 356, and the first and second memory interfaces 262 and 264. The write mapping module 356 receives address information from the host 220 indicating the logical addresses that will be more frequently written to. This information is provided to the wear leveling module 260, which biases the logical addresses to the second solid-state nonvolatile memory 206.

The write mapping module 356 may also include functionality similar to the write monitoring module 306 of FIG. 4A. The write mapping module 356 may therefore update stored write frequency data based on measured write frequency data. Additionally, the write mapping module 356 may determine write frequencies for the logical addresses that were not provided by the host 220. In other words, the write frequency data may be adjusted even if a logical address has not been accessed for a predetermined period. The wear leveling module 260 may store all data corresponding to the logical addresses that are flagged as frequently written to in the second solid-state nonvolatile memory 206.

If the second solid-state nonvolatile memory 206 is full, the write operations may be assigned to the first solid-state nonvolatile memory 204 and vice versa. Data can also be remapped and moved from the second solid-state nonvolatile memory 206 to the first solid-state nonvolatile memory 204 to create space in the second solid-state nonvolatile memory 206 and vice versa. Alternatively, data may be mapped solely to the first or the second solid-state nonvolatile memory 204, 206 when the wear level of the second or the first solid-state nonvolatile memory 206, 204 is greater than or equal to a predetermined threshold. It should be noted that the predetermined threshold for the wear level of the first and second solid-state nonvolatile memory 204, 206 may be the same or different. Furthermore, the predetermined threshold may vary at different points in time. For example, once a certain number of write operations have been performed on the first solid-state nonvolatile memory 204, the predetermined threshold may be adjusted to take into consideration the performed write operations.

The wear leveling module 260 may also implement the write monitoring module 306 and the write mapping module 356. Hereinafter, the wear leveling module 260 may also include the write monitoring module 306 and the write mapping module 356.

Referring now to FIG. 5, the solid-state disk 400 includes a controller 402 that interfaces with the host 220. The controller 402 includes the wear leveling module 260, a degradation testing module 406, and the first and second memory interfaces 262 and 264. The degradation testing module 406 tests the first and second solid-state nonvolatile memories 204 and 206 to determine whether their storage capability has degraded.

In various implementations, the degradation testing module 406 may test only the first solid-state nonvolatile memory 204, since the write cycle lifetime of the first solid-state nonvolatile memory 204 is less than the write cycle lifetime of the second solid-state nonvolatile memory 206. The degradation testing module 406 may periodically test for degradation. The degradation testing module 406 may wait for periods of inactivity, at which point the degradation testing module 406 may provide addresses and data to the first and/or second memory interfaces 262 and 264.

The degradation testing module 406 may write and then read data to selected areas of the first and/or second solid-state nonvolatile memories 204 and 206. The degradation testing module 406 can then compare the read data to the written data. In addition, the degradation testing module 406 may read data written in previous iterations of degradation testing.

Alternatively, the degradation testing module 406 may write the same data to the same physical address at first and second times. At each of the two times, the degradation testing module 406 may read back the data written. The degradation testing module 406 may determine a degradation value for the physical address by comparing the data read back at the two times or by comparing the data read back at the second time to the written data.

The wear leveling module 260 may adapt its mapping based on the degradation value measured by the degradation testing module 406. For example, the degradation testing module 406 may estimate a maximum write cycle count for a block based on the amount of degradation. The wear leveling module 260 may then use this maximum write cycle count for normalization.

Alternatively, the wear leveling module 260 may use the number of writes cycles remaining for a block to make assignment decisions. If one of the solid-state nonvolatile memories 204 and 206 is approaching the end of its usable lifetime (e.g., a predetermined threshold), the wear leveling module 260 may assign all new writes to the other one of the memories 204 and 206.

The wear leveling module 260 may also implement the degradation testing module 406. Hereinafter, the wear leveling module 260 includes the degradation testing module 406.

Referring now to FIG. 6, a small solid-state nonvolatile memory having faster access time may be used in combination with a large solid-state nonvolatile memory having slower access time. A solid-state disk 450 may include a controller 460, a first solid-state nonvolatile memory 462, and a second solid-state nonvolatile memory 464. The first solid-state nonvolatile memory 462 may be inexpensive and may have a high storage capacity and a high write cycle lifetime but a lower read/write speed (i.e., access time). The second solid-state nonvolatile memory 464 may be smaller in storage capacity, may be more expensive, and may have a high write cycle lifetime and a faster access time relative to the first solid-state nonvolatile memory 462.

The second solid-state nonvolatile memory 464 may have a write access time, a read access time, an erase time, a program time, or a cumulative access time that is shorter than that of the first solid-state nonvolatile memory 462. Accordingly, the second solid-state nonvolatile memory 464 may be used to cache data. The controller 460 may include the wear leveling module 260 and a mapping module 465. The wear leveling module 260 may also implement the mapping module. The mapping module 465 may map the logical addresses to the physical addresses of one of the first and second solid-state nonvolatile memory 462, 464 based on access times and/or storage capacities of the first and second solid-state nonvolatile memory 462, 464.

Specifically, the mapping module may receive data from the host 220 related to the frequencies and access times at which data may be written to the logical addresses. The mapping module 465 may map the logical addresses that are to be written more frequently and/or faster than others to the physical addresses of second solid-state nonvolatile memory 464. All other logical addresses may be mapped to the physical addresses of the first nonvolatile memory 462. The actual write frequencies access times may be updated by measuring write frequencies and/or access times when data is written. In doing so, the mapping module 465 may minimize overall access time for all accesses made to the solid-state disk 450 during read/write/erase operations.

Depending on the application executed by the host 220, the mapping module 465 may consider additional factors when mapping the logical addresses to one of the first and second solid-state nonvolatile memory 462, 464. The factors may include but are not limited to the length of a block being written and the access time with which the block needs to be written.

Referring now to FIGS. 7A-7E, a method 500 for providing a hybrid nonvolatile solid-state (NVS) memory system using first and second NVS memories having different write cycle lifetimes and storage capacities is shown. The first NVS memory has a lower write cycle lifetime and higher capacity than the second NVS memory.

In FIG. 7A, the method 500 begins at step 502. Control receives write frequencies for logical addresses where data is to be written from the host in step 504. Control maps the logical addresses having low write frequencies (e.g., having write frequencies less than a predetermined threshold) to the first NVS memory in step 506. Control maps the logical addresses having high write frequencies (e.g., having write frequencies greater than a predetermined threshold) to the second NVS memory in step 508.

Control writes data to the first and/or second NVS memories in step 510 according to the mapping generated in steps 506 and 508. Control measures actual write frequencies at which data is in fact written to the logical addresses and updates the mapping in step 512.

In FIG. 7B, control determines whether time to perform data shift analysis has arrived in step 514. If the result of step 514 is false, control determines whether time to perform degradation analysis has arrived in step 516. If the result of step 516 is false, control determines whether time to perform wear level analysis has arrived in step 518. If the result of step 514 is false, control returns to step 510.

In FIG. 7C, when the result of step 514 is true, control determines in step 520 if a number of write operations to a first block of the first NVS memory during a predetermined time is greater than or equal to a predetermined threshold. If the result of step 520 is false, control returns to step 516. If the result of step 520 is true, control maps the logical addresses that correspond to the first block to a second block of the second NVS memory in step 522.

Control determines in step 524 if the available memory in the second NVS memory is less than a predetermined threshold. If the result of step 524 is false, control returns to step 516. If the result of step 524 is true, control identifies a block of the second NVS memory is a LUB in step 526. Control maps the logical addresses that correspond to the LUB to a block of the first NVS memory in step 528, and control returns to step 516.

In FIG. 7D, when the result of step 516 is true, control writes data to a physical address at a first time in step 530. Control reads back the data from the physical address in step 532. Control writes data to the physical address at a second time (i.e., after a predetermined time after the first time) in step 534. Control reads back the data from the physical address in step 536. Control compares the data read back in step 532 to the data read back in step 536 and generates a degradation value for the physical address in step 538. Control updates the mapping in step 540, and control returns to step 518.

In FIG. 7E, when the result of step 518 is true, control generates wear levels for the first and second NVS memories in step 542 based on the number of write operations performed on the first and second memories and the write cycle lifetime ratings of the first and second memories, respectively. Control determines in step 544 if the wear level of the second NVS memory is greater than a predetermined threshold. If the result of step 544 is true, control maps all the logical blocks to physical blocks of the first NVS memory in step 546, and control returns to step 510.

If the result of step 544 is false, control determines in step 548 if the wear level of the first NVS memory is greater than a predetermined threshold. If the result of step 548 is true, control maps all the logical blocks to physical blocks of the second NVS memory in step 550 and, control returns to step 510. If the result of step 548 is false, control returns to step 510.

Referring now to FIG. 8, a method 600 for providing a hybrid nonvolatile solid-state (NVS) memory system for caching data using first and second NVS memories having different access times and storage capacities is shown. The first NVS memory has a higher access time and higher capacity than the second NVS memory. The first and second NVS memories have high write cycle lifetimes.

The method 600 begins at step 602. Control receives data related to write frequency and access time requirement for writing data to logical addresses from the host in step 604. Control maps the logical addresses having low write frequencies (e.g., having write frequencies less than a predetermined threshold) and/or requiring slower access times to the first NVS memory in step 606. Control maps the logical addresses having high write frequencies (e.g., having write frequencies greater than a predetermined threshold) and/or requiring faster access times to the second NVS memory in step 606. Control maps the logical addresses having low write frequencies (e.g., having write frequencies less than a predetermined threshold) and/or requiring slower access times to the first NVS memory in step 608.

Control writes data to the first and/or second NVS memories in step 610 according to the mapping generated in steps 606 and 608. Control measures actual write frequencies and/or actual access times at which data is in fact written to the logical addresses and updates the mapping in step 612. In step 614, control executes steps beginning at step 514 of the method 500 as shown in FIGS. 7A-7E.

Wear leveling modules according to the principles of the present disclosure may determine wear levels for each block of the first and second nonvolatile semiconductor memories (referred to as first and second memories). The term block may refer to the group of memory cells that must be written and/or erased together. For purposes of discussion only, the term block will be used for a group of memory cells that is erased together, and the wear level of a memory cell will be based on the number of erase cycles it has sustained.

The memory cells within a block will have experienced the same number of erases, although individual memory cells may not have been programmed when the erase was initiated, and thus may not experience as much wear. However, the wear leveling module may assume that the wear levels of the memory cells of a block can be estimated by the number of erase cycles the block has experienced.

The wear leveling module may track the number of erases experienced by each block of the first and second memories. For example, these numbers may be stored in a certain region of the first and/or second memories, in a separate working memory of the wear leveling module, or with their respective blocks. For example only, a predetermined area of the block, which is not used for user data, may be used to store the total number of times that block has been erased. When a block is going to be erased, the wear leveling module may read that value, increment the value, and write the incremented value to the block after the block has been erased.

With a homogeneous memory architecture, the erase count could be used as the wear level of a block. However, the first and second memories may have different lifetimes, meaning that the number of erases each memory cell can withstand is different. In various implementations, the second memory has a longer lifetime than the first memory. The number of erases each block can withstand is therefore greater in the second memory than in the first.

The number of erases performed on a block may therefore not be an appropriate comparison between a block from the first memory and a block of the second memory. To achieve appropriate comparisons, the erase counts can be normalized. One way of normalizing is to divide the erase count by the total number of erase counts a block in that memory is expected to be able to withstand. For example only, the first memory have a write cycle lifetime of 10,000, while the second memory has a write cycle lifetime of 100,000.

A block in the first memory that has been erased 1,000 times would then have a normalized wear level of 1/10, while a block in the second memory that has been erased 1,000 times would then have a normalized wear level of 1/100. Once the wear levels have been normalized, a wear leveling algorithm can be employed across all the blocks of both the first and second memories as if all the blocks formed a single memory having a singe write cycle lifetime. Wear levels as used herein, unless otherwise noted, are normalized wear levels.

Another way of normalizing, which avoids fractional numbers, is to multiply the erase counts of blocks in the first memory (having the lower write cycle lifetime) by the ratio of write cycle lifetimes. In the current example, the ratio is 10 (100,000/10,000). A block in the first memory that has been erased 1,000 times would then have a normalized wear level of 10,000, while a block in the second memory that has been erased 1,000 times would then have a normalized wear level of 1,000.

When a write request for a logical address arrives at the wear leveling module, the wear leveling module may determine if the logical address is already mapped to a physical address. If so, the wear leveling module may direct the write to that physical address. If the write would require an erase of the block, the wear leveling module may determine if there are any unused blocks with lower wear levels. If so, the wear leveling module may direct the write to the unused block having the lowest wear level.

For a write request to a logical address that is not already mapped, the wear leveling module may map the logical address to the unused block having the lowest wear level. If the wear leveling module expects that the logical address will be rewritten relatively infrequently, the wear leveling module may map the logical address to the unused block having the highest wear level.

When the wear leveling module has good data for estimating access frequencies, the wear leveling module may move data from a used block to free that block for an incoming write. In this way, an incoming write to a block that is relatively frequently accessed can be written to a block with a low wear level. Also, an incoming write to a block that is relatively infrequently accessed can be written to a block with a high wear level. The data that was moved can be placed in an unused block that may be chosen based on how often the moved data is expected to be rewritten.

At various times, such as periodically, the wear leveling module may analyze the wear levels of the blocks, and remap relatively frequently rewritten logical addresses to blocks with low wear levels. In addition, the wear leveling module may remap relatively infrequently rewritten logical addresses to blocks with high wear levels, which is known as static data shifting. Remapping may involve swapping data in two blocks. During the swap, the data from one of the blocks may be stored in an unused block, or in temporary storage.

The wear leveling module may also maintain a list of blocks that have surpassed their write cycle lifetime. No new data will be written to these blocks, and data that was previously stored in those blocks is written to other blocks. Although the goal of the wear leveling module is that no block wears out before the others, some blocks may wear out prematurely under real-world circumstances. Identifying and removing unreliable blocks allows the full lifetime of the remaining blocks to be used before the solid-state disk is no longer usable.

It should be understood that while the present disclosure, for illustration purposes, describes first and second solid-state nonvolatile memories 204, 206, the teachings of the present disclosure may also be applied to other types of memories. In addition, the memories may not be limited to individual modules. For example, the teachings of the present disclosure may be applied to memory zones within a single memory chip or across multiple memory chips. Each memory zone may be used to store data in accordance with the teachings of the present disclosure.

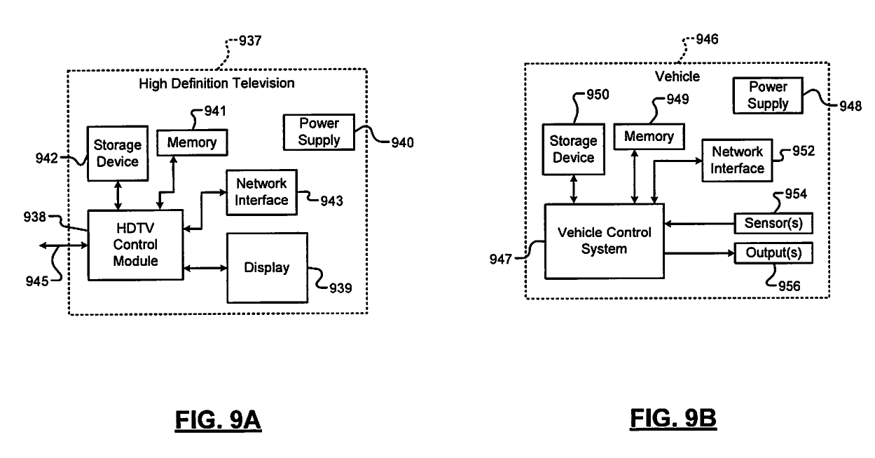

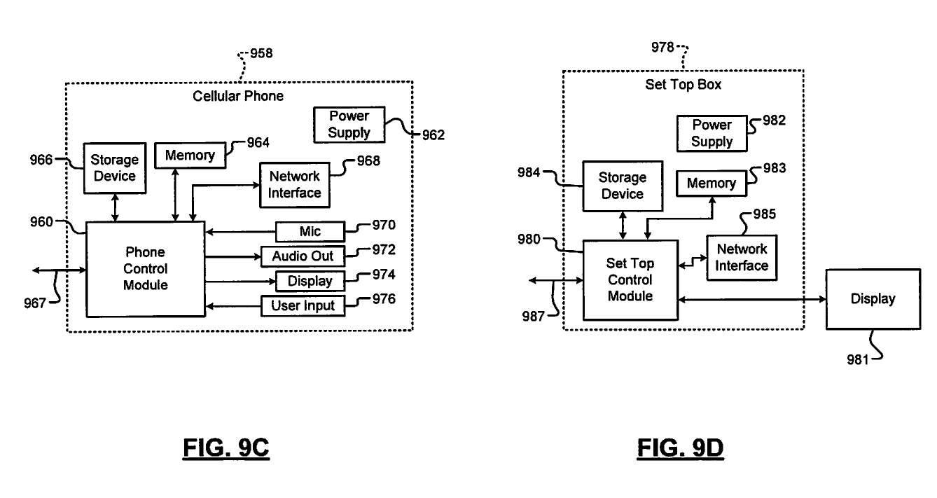

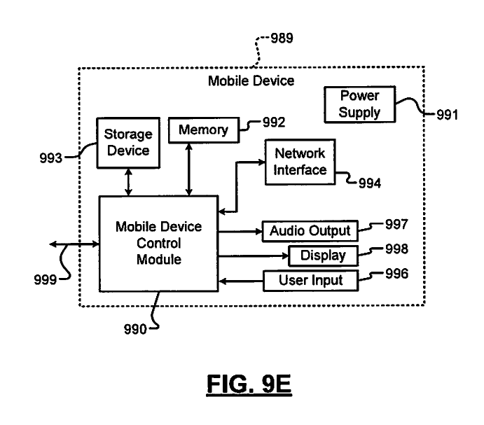

Referring now to FIGS. 9A-9E, various exemplary implementations incorporating the teachings of the present disclosure are shown. In FIG. 9A, the teachings of the disclosure can be implemented in a storage device 942 of a high definition television (HDTV) 937. The HDTV 937 includes an HDTV control module 938, a display 939, a power supply 940, memory 941, the storage device 942, a network interface 943, and an external interface 945. If the network interface 943 includes a wireless local area network interface, an antenna (not shown) may be included.

The HDTV 937 can receive input signals from the network interface 943 and/or the external interface 945, which can send and receive data via cable, broadband Internet, and/or satellite. The HDTV control module 938 may process the input signals, including encoding, decoding, filtering, and/or formatting, and generate output signals. The output signals may be communicated to one or more of the display 939, memory 941, the storage device 942, the network interface 943, and the external interface 945.

Memory 941 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 942 may include an optical storage drive, such as a DVD drive, and/or a hard disk drive (HDD). The HDTV control module 938 communicates externally via the network interface 943 and/or the external interface 945. The power supply 940 provides power to the components of the HDTV 937.

In FIG. 9B, the teachings of the disclosure may be implemented in a storage device 950 of a vehicle 946. The vehicle 946 may include a vehicle control system 947, a power supply 948, memory 949, the storage device 950, and a network interface 952. If the network interface 952 includes a wireless local area network interface, an antenna (not shown) may be included. The vehicle control system 947 may be a powertrain control system, a body control system, an entertainment control system, an anti-lock braking system (ABS), a navigation system, a telematics system, a lane departure system, an adaptive cruise control system, etc.

The vehicle control system 947 may communicate with one or more sensors 954 and generate one or more output signals 956. The sensors 954 may include temperature sensors, acceleration sensors, pressure sensors, rotational sensors, airflow sensors, etc. The output signals 956 may control engine operating parameters, transmission operating parameters, suspension parameters, etc.

The power supply 948 provides power to the components of the vehicle 946. The vehicle control system 947 may store data in memory 949 and/or the storage device 950. Memory 949 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 950 may include an optical storage drive, such as a DVD drive, and/or a hard disk drive (HDD). The vehicle control system 947 may communicate externally using the network interface 952.

In FIG. 9C, the teachings of the disclosure can be implemented in a storage device 966 of a cellular phone 958. The cellular phone 958 includes a phone control module 960, a power supply 962, memory 964, the storage device 966, and a cellular network interface 967. The cellular phone 958 may include a network interface 968, a microphone 970, an audio output 972 such as a speaker and/or output jack, a display 974, and a user input device 976 such as a keypad and/or pointing device. If the network interface 968 includes a wireless local area network interface, an antenna (not shown) may be included.

The phone control module 960 may receive input signals from the cellular network interface 967, the network interface 968, the microphone 970, and/or the user input device 976. The phone control module 960 may process signals, including encoding, decoding, filtering, and/or formatting, and generate output signals. The output signals may be communicated to one or more of memory 964, the storage device 966, the cellular network interface 967, the network interface 968, and the audio output 972.

Memory 964 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 966 may include an optical storage drive, such as a DVD drive, and/or a hard disk drive (HDD). The power supply 962 provides power to the components of the cellular phone 958.

In FIG. 9D, the teachings of the disclosure can be implemented in a storage device 984 of a set top box 978. The set top box 978 includes a set top control module 980, a display 981, a power supply 982, memory 983, the storage device 984, and a network interface 985. If the network interface 985 includes a wireless local area network interface, an antenna (not shown) may be included.

The set top control module 980 may receive input signals from the network interface 985 and an external interface 987, which can send and receive data via cable, broadband Internet, and/or satellite. The set top control module 980 may process signals, including encoding, decoding, filtering, and/or formatting, and generate output signals. The output signals may include audio and/or video signals in standard and/or high definition formats. The output signals may be communicated to the network interface 985 and/or to the display 981. The display 981 may include a television, a projector, and/or a monitor.

The power supply 982 provides power to the components of the set top box 978. Memory 983 may include random access memory (RAM) and/or nonvolatile memory. Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 984 may include an optical storage drive, such as a DVD drive, and/or a hard disk drive (HDD).

In FIG. 9E, the teachings of the disclosure can be implemented in a storage device 993 of a mobile device 989. The mobile device 989 may include a mobile device control module 990, a power supply 991, memory 992, the storage device 993, a network interface 994, and an external interface 999. If the network interface 994 includes a wireless local area network interface, an antenna (not shown) may be included.

The mobile device control module 990 may receive input signals from the network interface 994 and/or the external interface 999. The external interface 999 may include USB, infrared, and/or Ethernet. The input signals may include compressed audio and/or video, and may be compliant with the MP3 format. Additionally, the mobile device control module 990 may receive input from a user input 996 such as a keypad, touchpad, or individual buttons. The mobile device control module 990 may process input signals, including encoding, decoding, filtering, and/or formatting, and generate output signals.

The mobile device control module 990 may output audio signals to an audio output 997 and video signals to a display 998. The audio output 997 may include a speaker and/or an output jack. The display 998 may present a graphical user interface, which may include menus, icons, etc. The power supply 991 provides power to the components of the mobile device 989. Memory 992 may include random access memory (RAM) and/or nonvolatile memory.

Nonvolatile memory may include any suitable type of semiconductor or solid-state memory, such as flash memory (including NAND and NOR flash memory), phase change memory, magnetic RAM, and multi-state memory, in which each memory cell has more than two states. The storage device 993 may include an optical storage drive, such as a DVD drive, and/or a hard disk drive (HDD). The mobile device may include a personal digital assistant, a media player, a laptop computer, a gaming console, or other mobile computing device.

Those skilled in the art can now appreciate from the foregoing description that the broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A solid state memory system comprising:
a first nonvolatile semiconductor (NVS) memory that has a first write cycle lifetime;
a second nonvolatile semiconductor (NVS) memory that has a second write cycle lifetime that is different than said first write cycle lifetime; and
a wear leveling module that generates first and second wear levels for said first and second NVS memories based on said first and second write cycle lifetimes and that maps logical addresses to physical addresses of one of said first and second NVS memories based on said first and second wear levels.

2. The solid state memory system of claim 1 wherein said first wear level is substantially based on a ratio of a first number of write operations performed on said first NVS memory to said first write cycle lifetime, and wherein said second wear level is substantially based on a ratio of a second number of write operations performed on said second NVS memory to said second write cycle lifetime.

3. The solid state memory system of claim 1 wherein said wear leveling module maps said logical addresses to said physical addresses of said second memory when said second wear level is less than said first wear level.

4. The solid state memory system of claim 1 wherein said first NVS memory has a first storage capacity that is greater than a second storage capacity of said second NVS memory.

5. The solid state memory system of claim 1 further comprising a mapping module that receives first and second frequencies for writing data to first and second of said logical addresses, wherein said wear leveling module biases mapping of said first of said logical addresses to said physical addresses of said second NVS memory when said first frequency is greater than said second frequency and said second wear level is less than said first wear level.

6. The solid state memory system of claim 5 wherein said wear leveling module biases mapping of said second of said logical addresses to said physical addresses of said first NVS memory.

7. The solid state memory system of claim 5 further comprising a write monitoring module that monitors subsequent frequencies of writing data to said first and second of said logical addresses and that updates said first and second frequencies based on said subsequent frequencies.

8. The solid state memory system of claim 1 further comprising a write monitoring module that measures first and second frequencies of writing data to first and second of said logical addresses, wherein said wear leveling module biases mapping of said first of said logical addresses to said physical addresses of said second NVS memory when said first frequency is greater than said second frequency and said second wear level is less than said first wear level.

9. The solid state memory system of claim 8 wherein said wear leveling module biases mapping of said second of said logical addresses to said physical addresses of said first NVS memory.

10. The solid state memory system of claim 1 further comprising a degradation testing module that:
writes data at a first predetermined time to one of said physical addresses;
generates a first stored data by reading data from said one of said physical addresses;
writes data to said one of said physical addresses at a second predetermined time;
generates a second stored data by reading data from said one of said physical addresses; and
generates a degradation value for said one of said physical addresses based on said first and second stored data.

11. The solid state memory system of claim 10 wherein said wear leveling module maps one of said logical addresses to said one of said physical addresses based on said degradation value.

12. The solid state memory system of claim 1 wherein:
said wear leveling module maps said logical addresses to said physical addresses of said first NVS memory when said second wear level is greater than or equal to a first predetermined threshold; and
said wear leveling module maps said logical addresses to said physical addresses of said second NVS memory when said first wear level is greater than or equal to a second predetermined threshold.

13. The solid state memory system of claim 1 wherein when write operations performed on a first block of said physical addresses of said first NVS memory during a predetermined period are greater than or equal to a predetermined threshold, said wear leveling module biases mapping of corresponding ones of said logical addresses from said first block to a second block of said physical addresses of said second NVS memory.

14. The solid state memory system of claim 1 wherein said wear leveling module identifies a first block of said physical addresses of said second NVS memory as a least used block (LUB).

15. The solid state memory system of claim 14 wherein said wear leveling module biases mapping of corresponding ones of said logical addresses from said first block to a second block of said physical addresses of said first NVS memory when available memory in said second NVS memory is less than or equal to a predetermined threshold.

16. The solid state memory system of claim 1 wherein said first NVS memory comprises a flash device and said second NVS memory comprises a phase-change memory device.

17. The solid state memory system of claim 16 wherein said first NVS memory comprises a Nitride Read-Only Memory (NROM) flash device.

18. The solid state memory system of claim 1 wherein said first write cycle lifetime is less than said second write cycle lifetime.

19. A method comprising:
generating first and second wear levels for first and second nonvolatile semiconductor (NVS) memories based on first and second write cycle lifetimes, wherein said first and second write cycle lifetimes correspond to said first and second NVS memories, respectively; and
mapping logical addresses to physical addresses of one of said first and second NVS memories based on said first and second wear levels.

20. The method of claim 19 wherein said first wear level is substantially based on a ratio of a first number of write operations performed on said first NVS memory to said first write cycle lifetime, and wherein said second wear level is substantially based on a ratio of a second number of write operations performed on said second NVS memory to said second write cycle lifetime.

21. The method of claim 19 further comprising mapping said logical addresses to said physical addresses of said second memory when said second wear level is less than said first wear level.

22. The method of claim 19 wherein said first NVS memory has a first storage capacity that is greater than a second storage capacity of said second NVS memory.

23. The method of claim 19 wherein said first write cycle lifetime is less than said second write cycle lifetime.

24. The method of claim 19 further comprising:
receiving first and second frequencies for writing data to first and second of said logical addresses; and
biasing mapping of said first of said logical addresses to said physical addresses of said second NVS memory when said first frequency is greater than said second frequency and said second wear level is less than said first wear level.

25. The method of claim 24 further comprising biasing mapping of said second of said logical addresses to said physical addresses of said first NVS memory.

26. The method of claim 24 further comprising:
monitoring subsequent frequencies of writing data to said first and second of said logical addresses; and
updating said first and second frequencies based on said subsequent frequencies.

27. The method of claim 19 further comprising:
measuring first and second frequencies of writing data to first and second of said logical addresses; and
biasing mapping of said first of said logical addresses to said physical addresses of said second NVS memory when said first frequency is greater than said second frequency and said second wear level is less than said first wear level.

28. The method of claim 27 further comprising biasing mapping of said second of said logical addresses to said physical addresses of said first NVS memory.

29. The method of claim 19 further comprising:
writing data at a first predetermined time to one of said physical addresses;
generating a first stored data by reading data from said one of said physical addresses;
writing data to said one of said physical addresses at a second predetermined time;
generating a second stored data by reading data from said one of said physical addresses; and
generating a degradation value for said one of said physical addresses based on said first and second stored data.

30. The method of claim 29 further comprising mapping one of said logical addresses to said one of said physical addresses based on said degradation value.

31. The method of claim 19 further comprising:
mapping said logical addresses to said physical addresses of said first NVS memory when said second wear level is greater than or equal to a first predetermined threshold; and
mapping said logical addresses to said physical addresses of said second NVS memory when said first wear level is greater than or equal to a second predetermined threshold.

32. The method of claim 19 wherein when write operations performed on a first block of said physical addresses of said first NVS memory during a predetermined period are greater than or equal to a predetermined threshold, biasing mapping of corresponding ones of said logical addresses from said first block to a second block of said physical addresses of said second NVS memory.

33. The method of claim 19 further comprising identifying a first block of said physical addresses of said second NVS memory as a least used block (LUB).

34. The method of claim 33 further comprising biasing mapping of corresponding ones of said logical addresses from said first block to a second block of said physical addresses of said first NVS memory when available memory in said second NVS memory is less than or equal to a predetermined threshold.

35. The method of claim 19 wherein said first NVS memory comprises a flash device and said second NVS memory comprises a phase-change memory device.

36. The method of claim 35 wherein said first NVS memory comprises a Nitride Read-Only Memory (NROM) flash device.

37. The solid state memory system of claim 1 wherein said second NVS memory includes single-level cell (SLC) flash memory and said first NVS memory include multi-level cell (MLC) flash memory.

38. The solid state memory system of claim 1 wherein said first NVS memory has a first access time and said second NVS memory has a second access time that is shorter than said first access time, wherein said wear leveling module maps first logical addresses to said first NVS memory and second logical addresses to said second NVS memory and wherein said first logical addresses are accessed less frequently than said second logical addresses.

39. The method of claim 19 wherein said second NVS memory includes single-level cell (SLC) flash memory and said first NVS memory include multi-level cell (MLC) flash memory.

40. The method of claim 19 wherein said first NVS memory has a first access time and said second NVS memory has a second access time that is shorter than said first access time, the method further comprising mapping first logical addresses to said first NVS memory and second logical addresses to said second NVS memory, wherein said first logical addresses are accessed less frequently than said second logical addresses.
